(19) United States
(12) Patent Application Publication
(10) Pub. No.: US 2011/0317262 A1
(43) Pub. Date: Dec. 29, 2011

(54) Optical Film and Stereoscopic Display Using the Same

(75) Inventors: Hsin-Han Hsu, Pingzhen City (TW); Fung-Hsu Wu, Gueishan Township (TW)

(73) Assignee: BenQ MATERIALS CORP., Gueishan Township (TW)

(21) Appl. No.: 12/893,419

(22) Filed: Sep. 29, 2010

(30) Foreign Application Priority Data
Jun. 24, 2010 (TW) 99120691

(51) Int. Cl. G02B 27/22; G02B 27/12

(52) U.S. Cl. 359/463; 359/622

(57) ABSTRACT

An optical film used in a display panel is provided. The display panel has a number of pixels. The optical film includes a condenser lens array layer and a prism array layer. The condenser lens array layer, disposed in front of the pixels, includes a number of condenser lenses and at least has a first portion and a second portion, wherein the first portion and the second portion do not overlap with each other. The prism array layer at least includes a first prism sub-array having a number of first prisms. The light passing through the condenser lenses in the first portion of the condenser lens array layer is deflected to a first direction by the first prisms. The light passing through the condenser lenses in the second portion of the condenser lens array layer travels along a second direction. The first direction is different from the second direction.

This application claims the benefit of Taiwan application Serial No. 99120691, filed Jun. 24, 2010, the subject matter of which is incorporated herein by reference.

### BACKGROUND OF THE INVENTION

1. Field of the Invention

The invention relates in general to a stereoscopic display, and more particularly to a stereoscopic display using an optical film.

2. Description of the Related Art

Conventionally, the stereoscopic effect of image is normally achieved by way of a wearing device such as polarized glasses. According to the most commonly used stereoscopic display technology, a light source, such as a cold cathode ray tube, is added to each of the two sides of the backlight module. By turning on the light sources disposed at the two sides of the backlight module at different times and controlling the pixels to output different image signals at different times, the viewer's left eye and right eye will receive different images, hence the stereoscopic effect of displays is achieved.

However, the practice of adding a light source to each side of the backlight module must be accompanied by the disposition of an optical element which deflects the optical path of the light emitted by the backlight module, making the assembly of the backlight module more complicated. Thus, how to achieve the stereoscopic effect of displays without increasing assembly complexity has become a prominent task for the industries.

### SUMMARY OF THE INVENTION

The invention is directed to an optical film and a stereoscopic display using the same. The optical film of the invention can be directly disposed on the display panel to produce a stereoscopic effect on the displayed images. In comparison to the designs based on existing stereoscopic display technology, the invention is easier and much more convenient.

According to a first aspect of the present invention, an optical film used in a display panel is provided. The display panel has a number of pixels. The optical film includes a condenser lens array layer and a prism array layer. The condenser lens array layer, disposed in front of the pixels, includes a number of condenser lenses and at least has a first portion and a second portion, wherein the first portion and the second portion do not overlap with each other. The prism array layer at least includes a first prism sub-array having a number of first prisms. The light passing through the condenser lenses in the first portion of the condenser lens array layer is deflected to a first direction by the first prisms. The light passing through the condenser lenses in the second portion of the condenser lens array layer travels along a second direction. The first direction is different from the second direction.

According to a second aspect of the present invention, a stereoscopic display is provided. The stereoscopic display includes a display panel and an optical film. The display panel has a number of pixels. The optical film includes a condenser lens array layer and a prism array layer. The condenser lens array layer, disposed in front of the pixels, includes a number of condenser lenses and at least has a first portion and a second portion, wherein the first portion and the second portion do not overlap with each other. The prism array layer at least includes a first prism sub-array having a number of first prisms. The light passing through the condenser lenses in the first portion of the condenser lens array layer is deflected to a first direction by the first prisms. The light passing through the condenser lenses in the second portion of the condenser lens array layer travels along a second direction. The first direction is different from the second direction.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A shows a stereoscopic display according to a first embodiment of the invention;

FIG. 1B shows a partial optical path of the stereoscopic display of FIG. 1A during operation;

FIG. 2A shows a stereoscopic display according to a second embodiment of the invention;

FIG. 2B shows a partial optical path of the stereoscopic display of FIG. 2A during operation;

FIG. 3A shows a stereoscopic display according to a third embodiment of the invention; and

FIG. 3B shows a partial optical path of the stereoscopic display of FIG. 3A during operation.

### DETAILED DESCRIPTION OF THE INVENTION

A stereoscopic display including a display panel and an optical film is disclosed in the present invention. The display panel has a number of pixels. The optical film includes a condenser lens array layer and a prism array layer. The condenser lens array layer has a number of condenser lenses. The condenser lens array layer is disposed in front of the pixels, and at least has a first portion and a second portion, wherein the first portion and the second portion do not overlap with each other. The prism array layer at least includes a first prism sub-array having a number of first prisms. The light passing through the condenser lenses in the first portion of the condenser lens array layer is deflected to a first direction by the first prisms. The light passing through the condenser lenses in the second portion of the condenser lens array layer travels along a second direction. The first direction is different from the second direction, so that the images displayed on the stereoscopic display panel produce the stereoscopic effect.

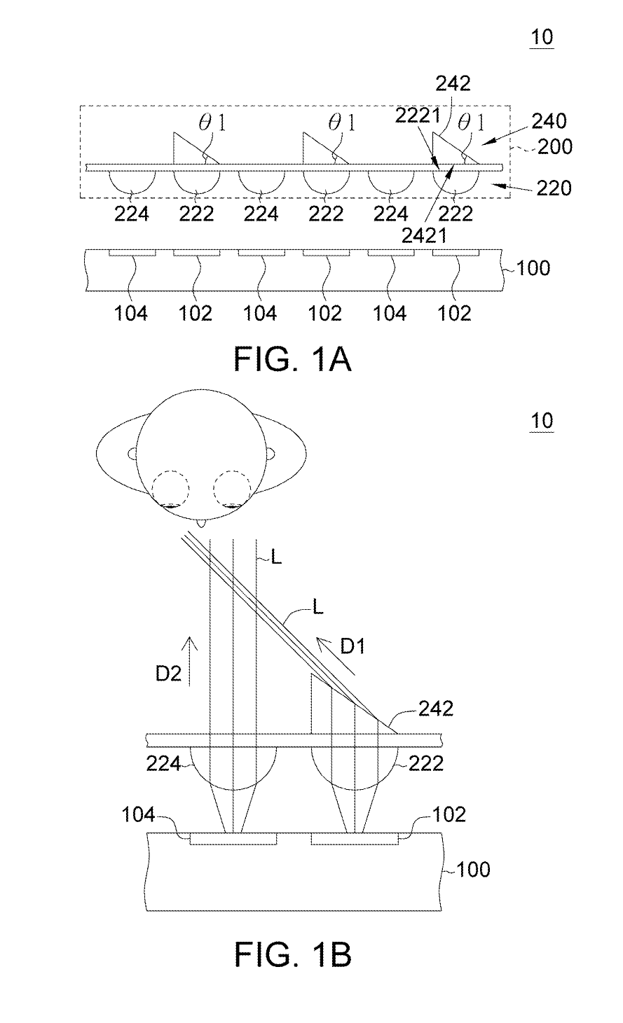

Referring to both FIGS. 1A and 1B, FIG. 1A shows a stereoscopic display according to a first embodiment of the invention, and FIG. 1B shows a partial optical path of the stereoscopic display of FIG. 1A during operation. As indicated in FIG. 1A, the stereoscopic display 10 includes a display panel 100 and an optical film 200. The display panel 100 can be, for example, a liquid crystal display (LCD) panel or an organic light-emitting diode (OLED) panel. The display panel 100 has a number of pixels 102 and 104 for outputting images of different angles.

The optical film 200 includes a condenser lens array layer 220 and a prism array layer 240. The condenser lens array layer 220 includes a number of condenser lenses, such as a number of condenser lenses 222 in the first portion and a number of condenser lenses 224 in the second portion. In the present embodiment of the invention, the pixels 102 and 104 are respectively disposed at the vertexes of the condenser lenses 222 and 224. Preferably, the pixels 102 and 104 are respectively disposed at the focal points of the condenser lenses 222 and 224, which are related to the curvature radius of the condenser lenses. However, the invention is not limited to such exemplification, and any designs enabling the light emitted by the pixels 102 and 104 to become parallel light after passing through the condenser lenses 222 and 224 will do.

The condenser lenses 222 can be realized by such as semicircular lenses or semi-cylindrical lenses. However, the invention is not limited thereto, and any designs of the condenser lenses enabling the light emitted by the pixels 102 and 104 to become parallel light after passing through the condenser lenses 222 and 224 respectively are within the scope of the present invention. The prism array layer 240 includes a first prism sub-array. The first prism sub-array has a number of first prisms 242 disposed in front of the pixels 102 in a one-to-one manner, that is, one first prism 242 corresponds to one pixel 102. Moreover, the condenser lenses 222 form a plane 2221, and the first prisms 242 form a surface 2421, wherein the plane 2221 and the surface 2421 are opposite to each other. In another embodiment, the plane 2221 and the surface 2421 can be directly contacted with each other.

As indicated in FIG. 1B, the light L passing through the condenser lenses 222 in the first portion of the condenser lens array layer 220 is deflected to a first direction D1 by the first prisms 242. The light L passing through the condenser lenses in the second portion of the condenser lens array layer L travels along a second direction D2. The first direction D1 is different from the second direction D2. Thus, the images created by the pixels 102 and 104 have different angles, and when the images are received by the left eye and the right eye of the viewer respectively, a stereoscopic effect will thus be achieved.

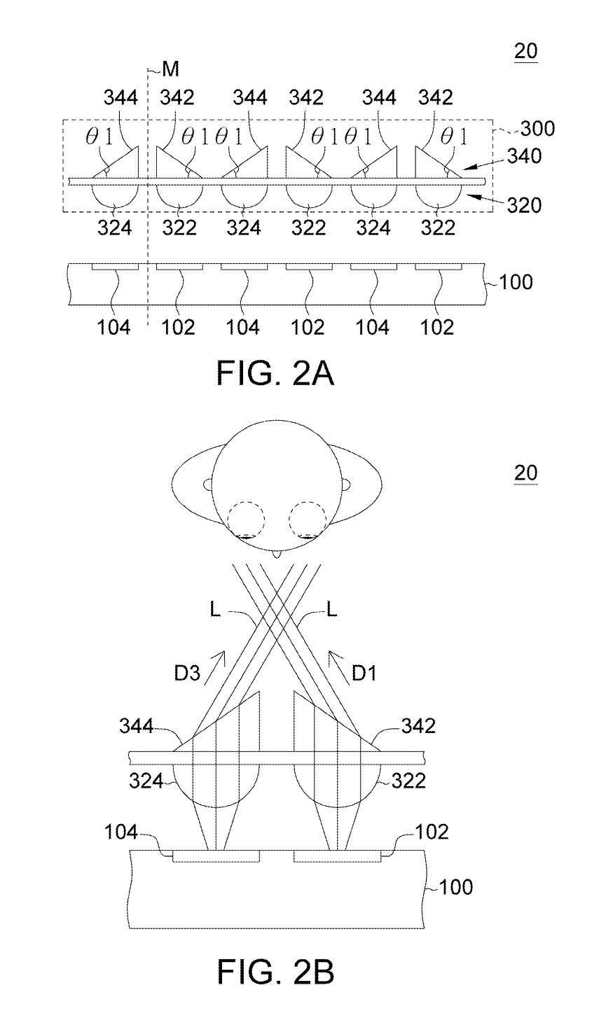

Referring to both FIGS. 2A and 2B, FIG. 2A shows a stereoscopic display according to a second embodiment of the invention and FIG. 2B shows a partial optical path of the stereoscopic display of FIG. 2A during operation. As indicated in FIG. 2A, the stereoscopic display 20 includes a display panel 100 and an optical film 300. The stereoscopic display 20 of FIG. 2A is different from the stereoscopic display 10 of FIG. 1A in that the prism array layer of the stereoscopic display 20 of FIG. 2A further includes a second prism sub-array having a number of second prisms 344, and the first prisms 342 of the first prism sub-array are interlaced with the second prisms 344 of the second prism sub-array.

Each of the second prisms 344 and its adjacent first prism 342 are symmetric with respect to the middle line of the two prisms. As indicated in FIG. 2A, each of the second prisms 344 and its adjacent first prism 342 are symmetric with respect to the middle line M. That is, the first prisms 342 and the second prisms 344 have the same base angle θ₁. Moreover, the first prisms 342 and the second prisms 344 are disposed in front of the pixels 102 and 104 respectively in a one-to-one manner. That is, one first prism 342 corresponds to one pixel 102, and one second prism 344 corresponds to one pixel 104.

As indicated in FIG. 2B, the light L passing through the condenser lenses 324 in the second portion of the condenser lens array layer is deflected to a third direction D3 by the second prisms 344. The third direction D3 of the present embodiment of the invention is different from the second direction D2 of the first embodiment. The first prisms 342 enable the light L passing through the condenser lenses 322 in the first portion to be deflected to a first direction D1, and the second prisms 344 enable the light L passing through the condenser lenses 324 in the second portion to be deflected to a third direction D3, so that the images created by the pixels 102 and 104 have different angles. When the different images are received by the left eye and the right eye of the viewer respectively, a stereoscopic effect will thus be achieved.

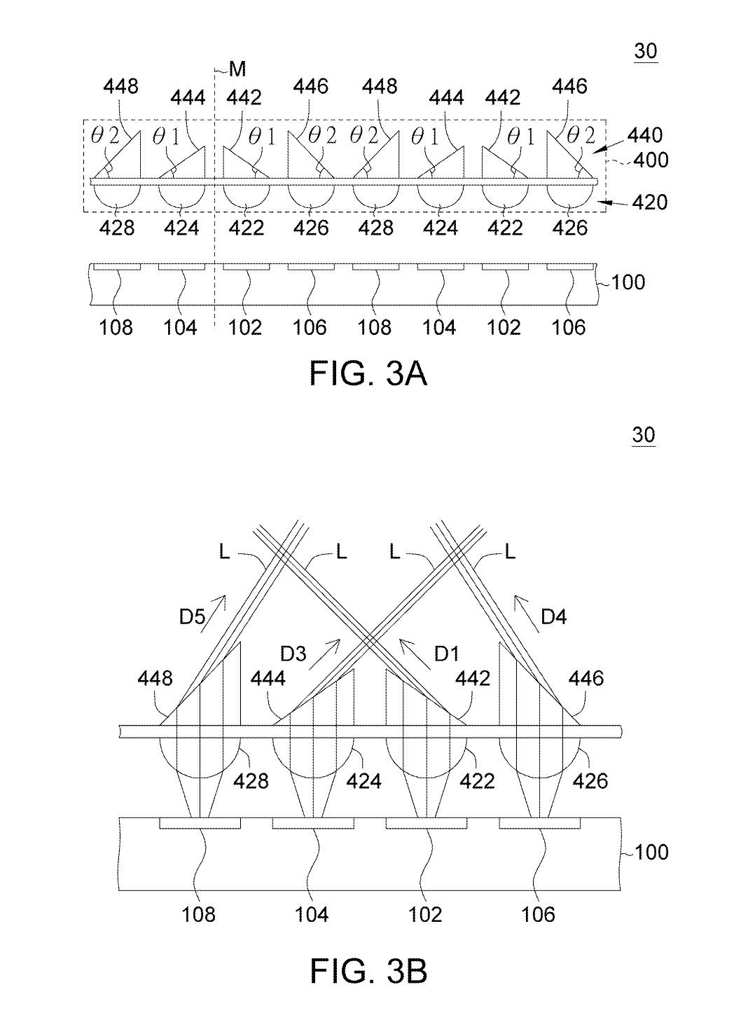

Referring to FIGS. 3A and 3B, FIG. 3A shows a stereoscopic display according to a third embodiment of the invention, and FIG. 3B shows a partial optical path of the stereoscopic display of FIG. 3A during operation. As indicated in FIG. 3A, the stereoscopic display 30 includes a display panel 100 and an optical film 400. The stereoscopic display 30 of FIG. 3 is different from the stereoscopic display 20 of FIG. 2 in that the prism array layer 440 of the stereoscopic display 30 of FIG. 3 further includes a third prism sub-array and a fourth prism sub-array. The third prism sub-array and the fourth prism sub-array respectively have a number of third prisms 446 and a number of fourth prisms 448. The third prisms 446 and the fourth prisms 448 have the same base angle θ₂. The base angle θ₂ of the third prisms 446 and the fourth prisms 448 is different from the base angle θ₁ of the first prisms 442 and the second prisms 444. In addition, each of the first prisms 442 and its corresponding second prism 444 are symmetric with respect to the middle line M, and each of the third prisms 446 and its corresponding fourth prism 448 are also symmetric with respect to the middle line M.

The first prisms 442, the second prisms 444, the third prisms 446 and the fourth prisms 448 are disposed in front of the pixels 102, 104, 106 and 108 in a one-to-one manner, respectively. That is, the first prisms 442 correspond to the pixels 102 in a one-to-one manner, the second prisms 444 correspond to the pixels 104 in a one-to-one manner, the third prisms 446 correspond to the pixels 106 in a one-to-one manner, and the fourth prisms 448 correspond to the pixels 108 in a one-to-one manner. In addition, the first prisms 442, the second prisms 444, the third prisms 446, and the fourth prisms 448 are sequentially interlaced. That is, in the prism array layer 440, the first prisms 442, the second prisms 444, the third prisms 446, and the fourth prisms 448 are sequentially arranged in a repetitive pattern.

As indicated in FIG. 3B, the light L passing through the condenser lenses 426 of a third portion of condenser lens array layer is deflected to a fourth direction D4 by the third prisms 446, and the light L passing through the condenser lenses 428 of a fourth portion of the condenser lens array layer is deflected to a fifth direction D5 by the fourth prisms 448. The fourth direction D4 and the fifth direction D5 of the present embodiment of the invention and the first direction D1 and the third direction D3 of the second embodiment are all different, so that the images formed by the pixels 102, 104, 106 and 108 have different angles, and when the images are received by the left eye and the right eye of the viewer respectively, a stereoscopic effect will thus be achieved.

The present embodiment of the invention is exemplified by a stereoscopic display having 4 view-angles. However, anyone who is skilled in the technology of the invention will understand that the technology of the invention can also be applied to a stereoscopic display having 6 view-angles, 8 view-angles, or more than 8 view-angles.

The present invention discloses an optical film which is disposed in front of the display panel. Since the existing manufacturing process of the display panel or the backlight module does not need to be changed, the cost and complexity of the manufacturing process can be largely reduced. Furthermore, the optical film of the present invention can be directly and easily disposed on the display. In comparison to the conventional method which has to dispose an extra light source and corresponding optical elements on the backlight module and requires a controlling method for the light source, the design of invention achieves a stereoscopic effect of display by way of a much more simplified design which is easier to implement, incurs much lower cost, and does not need to apply additional control on the light source. Moreover, since the optical film of the present invention helps to concentrate the light sources in the central region, the intensities of the light in the two sides are lower. Thus, the stereoscopic display of the present invention further has anti-peeping effect.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical film used in a display panel having a plurality of pixels, the optical film comprising:
a condenser lens array layer having a plurality of condenser lenses, wherein the condenser lens array layer is disposed in front of the pixels and at least has a first portion and a second portion, and the first portion and the second portion do not overlap with each other; and
a prism array layer, at least comprising:
a first prism sub-array having a plurality of first prisms for deflecting the light passing through the condenser lenses in the first portion of the condenser lens array layer to a first direction;
wherein the light passing through the condenser lenses in the second portion of the condenser lens array layer travels along a second direction, and the first direction is different from the second direction, so that the images displayed on the stereoscopic display panel produce stereoscopic effect.

2. The optical film according to claim 1, wherein the prism array layer further comprises a second prism sub-array having a plurality of second prisms for deflecting the light passing through the condenser lenses in the second portion of the condenser lens array layer to a third direction, and the third direction is different from the second direction.

3. The optical film according to claim 2, wherein the first prisms and the second prisms are interlaced.

4. The optical film according to claim 3, wherein each of the second prisms and its adjacent first prism are symmetric with respect to a middle line.

5. The optical film according to claim 2, wherein the prism array layer further comprises a third prism sub-array and a fourth prism sub-array, the third prism sub-array and the fourth prism sub-array respectively have a plurality of third prisms and a plurality of fourth prisms, the condenser lens array layer further comprises a third portion and a fourth portion, the first to the fourth portion do not overlap with one another, the light passing through the condenser lenses of the third portion of the condenser lens array layer is deflected to a fourth direction by the third prisms, the light passing through the condenser lenses of the fourth portion of the condenser lens array layer is deflected to a fifth direction by the fourth prisms, the first, the third, the fourth, the fifth direction are different from one another.

6. The optical film according to claim 5, wherein the first prisms, the second prisms, the third prisms, the fourth prisms are sequentially interlaced.

7. The optical film according to claim 6, wherein each of first prisms and its corresponding second prism are symmetric with respect to a middle line, each of the third prisms and its corresponding fourth prism are also symmetric with respect to the middle line.

8. The optical film according to claim 1, wherein the condenser lenses are semi-cylindrical lenses.

9. The optical film according to claim 8, wherein the semi-cylindrical lenses form a plane, the first prisms form a surface, and the plane and the surface are opposite to each other.

10. The optical film according to claim 1, wherein the first prisms are disposed in front of the pixels in a one-to-one manner.

11. A stereoscopic display comprising:
a display panel having a plurality of pixels; and
an optical film, comprising:
a condenser lens array layer having a plurality of condenser lenses, wherein the condenser lens array layer is disposed in front of the pixels and at least has a first portion and a second portion, and the first portion and the second portion do not overlap with each other; and
a prism array layer, at least comprising:
a first prism sub-array having a plurality of first prisms for deflecting the light passing through the condenser lenses in the first portion of the condenser lens array layer to a first direction;
wherein the light passing through the condenser lenses in the second portion of the condenser lens array layer travels along a second direction, and the first direction is different from the second direction, so that the images displayed on the stereoscopic display panel produce stereoscopic effect.

12. The stereoscopic display according to claim 11, wherein the prism array layer further comprises a second prism sub-array having a plurality of second prisms for deflecting the light passing through the second portion of the condenser lens array layer to a third direction, and the third direction is different from the second direction.

13. The stereoscopic display according to claim 12, wherein the first prisms and the second prisms are interlaced.

14. The stereoscopic display according to claim 13, wherein each of the second prisms and its adjacent first prism are symmetric with respect to a middle line.

15. The stereoscopic display according to claim 11, wherein the prism array layer further comprises a third prism sub-array and a fourth prism sub-array, the third prism sub-array and the fourth prism sub-array respectively have a plurality of third prisms and a plurality of fourth prisms, the condenser lens array layer further comprises a third portion and a fourth portion, the first to the fourth portion do not overlap with one another, the light passing through the condenser lenses of the third portion of the condenser lens array layer is deflected to a fourth direction by the third prisms, the light passing through the condenser lenses of the fourth portion of the condenser lens array layer is deflected to a fifth direction by the fourth prisms, the first, the third, the fourth, the fifth direction are different from one another.

16. The stereoscopic display according to claim 15, wherein the first prisms, the second prisms, the third prisms, the fourth prisms are sequentially interlaced.

17. The stereoscopic display according to claim 16, wherein each of first prisms and its corresponding second prism are symmetric with respect to a middle line, each of the third prisms and its corresponding fourth prism are also symmetric with respect to the middle line.

18. The stereoscopic display according to claim 11, wherein the pixels are disposed at the focal points of the condenser lenses.

19. The stereoscopic display according to claim 11, wherein the condenser lenses are semicircular lenses or semi-cylindrical lenses, the semi-cylindrical lenses form a plane, the first prisms form a surface, and the plane and the surface are opposite to each other.

20. The stereoscopic display according to claim 11, wherein the stereoscopic display is a liquid crystal display (LCD) or an organic light-emitting diode (OLED).
